(19) United States
(12) Patent Application Publication
(10) Pub. No.: US 2002/0048051 A1
(43) Pub. Date: Apr. 25, 2002

(54) Facsimile apparatus

(76) Inventors: Shinichi Momonami, Nara-shi (JP); Toyofumi Fujiwara, Tokyo (JP)

Correspondence Address: BIRCH STEWART KOLASCH & BIRCH, PO BOX 747, FALLS CHURCH, VA, 22040-0747, US

(21) Appl. No.: 09/970,683

(22) Filed: Oct. 5, 2001

(30) Foreign Application Priority Data
Oct. 6, 2000 (JP) 2000-308228

(51) Int. Cl. H04N 1/00

(52) U.S. Cl. 358/440

(57) ABSTRACT

On a displaying unit, there are displayed facsimile numbers or names of destinations as contents of the first table stored in a storage device, from which a user selects a destination to which the user desires to transmit a facsimile by using dialing keys and operation keys. When the desired destination is selected, functions or items of additional information corresponding to the selected destination are displayed on the displaying unit. When the user selects a function which the user desires to use or an item of the additional information which the user desires to transmit, the controlling unit transmits the selected item of the additional information to the selected destination. A facsimile apparatus that can facilitate selection of items of additional information transmitted to a destination with improved convenience is provided.

### BACKGROUND OF THE INVENTION

1. Field of the Invention

The present invention relates to a facsimile apparatus in which a facsimile number of a destination and items of additional information to be transmitted in phase B are inputted.

2. Description of the Related Art

A facsimile apparatus is provided with a confidential reception function and a transition multi-destination calling function as important functions. However, these functions were realized by each facsimile manufacturer as those original to the manufacturer with its own procedure used individually in each manufacturer. Hence, with an object of realizing standard functions common to every facsimile apparatus from every manufacturer, a method has been developed as F-code.

When a sub-address (SUB) signal, a password (PWD) signal and a selective polling (SEP) signal are transmitted in F-code in facsimile transmission procedure phase B, input of data of 20 digits at the maximum is necessitated subsequent to input of a facsimile number. Although the facsimile number can be easily selectedby established methods such as one-touch dialing or abbreviated dialing, it is necessary to provide a method of easily inputting data such as the SUB signal.

A facsimile apparatus disclosed in Japanese Unexamined Patent Publication JP-A 10-322539 (1998) stores data of SUB signals, PWD signals and SEP signals in an electronic telephone directory for storing abbreviated dialing numbers, one-touch dialing numbers together with them. Thus, by selecting a destination by the electronic telephone directory, the SUB signal and other signals will be automatically specified. In this case, designation of the destination by the electronic telephone directory uniformly determines data to be transmitted in phase B in the facsimile transmission procedure such as the SUB signal accompanied therewith to allow data inputting work to be significantly reduced.

The facsimile apparatus disclosed in JP-A 10-322539 stores a facsimile number of a destination in correspondence with a signal to be transmitted to the destination. In such a facsimile apparatus, when a plurality of reception boxes are provided at the destination, and a plurality of users transmit facsimiles by using the same facsimile apparatus to the respective reception boxes of the same destination each with a different number, for example, the respective reception box numbers at the destination must be separately designated from one another. This is made possible to some degrees in this case by storing the facsimile number of the same destination in a plurality, to each a different reception box being designated. However, it is impossible to carry out operations with much flexibility such that items of information of a part of the boxes are made confidential.

### SUMMARY OF THE INVENTION

It is an object of the invention to provide a facsimile apparatus which facilitates selection of items of additional information transmitted to a destination with improved convenience.

For achieving the above object, the invention provides a facsimile apparatus comprising a first table for storing a facsimile number of a destination of call, a second table for storing items of additional information to be transmitted to the destination, selecting means for separately selecting the destination and the items of the additional information from the first table and the second table, and controlling means for controlling so that, when the destination and the items of the additional information are selected, a call out is made by combining the facsimile number of the selected destination and the items of the additional information.

According to the invention, the call out is made by combining the destination and the items of the additional information selected by the user from the first table and the second table. This facilitates selection of the items of the additional information to be transmitted to the destination.

In the invention it is preferable that the items of the additional information include at least one of a sub-address (SUB) signal, a password (PWD) signal, and a selective polling (SEP) signal.

According to the invention, the items of the additional information including at least one of the sub-address (SUB) signal, the password (PWD) signal, and the selective polling (SEP) signal allow the facsimile apparatus to use such functions as confidential, relay, and a bulletin board.

In the invention it is preferable that the SUB signal, the PWD signal, and the SEP signal are corresponding to signals with functions of F-code specified by CIAJ (Communications Industry Association of Japan) or functions equivalent thereto.

According to the invention, since the SUB signal, the PWD signal, and the SEP signal are corresponding to signals with functions of F-code specified by CIAJ (Communications Industry Association of Japan) or functions equivalent thereto, this allows the facsimile apparatus to communicate with facsimile apparatus produced by other manufacturers in which signals with functions of F-code are used.

In the invention, it is preferable that facsimile numbers and names of destinations on the other end are stored in the first table, information items defining characteristics of the items of the additional information are stored in the second table and that displaying means for displaying the facsimile number or the name of the destination, and the information items defining the characteristics of the items of the additional information during the selection.

According to the invention, since when the user carries out the above selection, the facsimile number or the name of the destination, and the information items defining the characteristics of the items of the additional information are displayed, the destination to which transmission is desired and items of the additional information corresponding to functions desired to be used can be easily selected and transmitted.

In the invention it is preferable that a function for making a call out by using contents of the first or second table can be canceled and reset.

According to the invention, since the function for making the call out by using contents of the first or second table, can be canceled and reset, this allows highly confidential information to be protected.

In the invention, it is preferable that all or a part of contents of the second table are made secret and, after a user is identified as being allowed to use the contents of the second table, the contents are disclosed.

According to the invention, since all or apart of contents of the second table are made secret and, after a user is identified as being allowed to use the contents of the second table, the contents are disclosed, highly confidential information can be more fully protected.

In the invention, it is preferable that items of information designating a destination are stored in the second table and, when displaying contents of the second table, items of additional information in the second table corresponding to a facsimile number or name of a destination selected from the first table are displayed with priority.

According to the invention, since when displaying contents of the second table, items of additional information in the second table corresponding to a facsimile number or name of a destination selected from the first table are displayed with priority, the items of the additional information can be distinguished from other kinds of information and can be easily selected.

As described in the foregoing, according to the invention, a method can be provided which can facilitate selection of the items of the additional information to be transmitted to a destination with improved convenience.

According to the invention, such functions as confidential, relay, and a bulletin board can be used.

According to the invention, it is possible to communicate with facsimile apparatus produced by other manufacturers in which signals with functions of F-code are used.

According to the invention, a destination to which transmission is desired and items of the additional information corresponding to functions desired to be used can be easily selected and transmitted.

According to the invention, highly confidential information can be fully protected.

According to the invention, since items of additional information desired to be transmitted to a facsimile number or names of destinations selected from the first table are displayed with priority, the items of the additional information can be distinguished from other kinds of information and can be easily selected.

### BRIEF DESCRIPTION OF THE DRAWINGS

Other and further objects, features, and advantages of the invention will be more explicit from the following detailed description taken with reference to the drawings wherein:

FIG. 1 is a block diagram showing a configuration of a facsimile apparatus 10 as an embodiment of the invention;

FIG. 2 is a diagram showing a transmission control procedure in the facsimile apparatus;

FIG. 3 is a diagram showing a transmission control procedure in the facsimile apparatus during selective polling;

FIG. 4 is a view of a managing table stored in a called facsimile apparatus;

FIG. 5 is a view showing a first table according to the invention;

FIG. 6 is a view showing a second table according to the invention;

FIG. 7 is a flow chart showing an operation procedure of a controlling unit employed in the facsimile apparatus according to the invention;

FIG. 8 is a diagram showing contents displayed in the displaying unit during selection of additional information; and

FIG. 9 is a diagram showing contents displayed in the displaying unit after selection of destination and additional information.

### DETAILED DESCRIPTION OF THE PREFERRED EMBODIMENTS

Now referring to the drawings, preferred embodiments of the invention are described below.

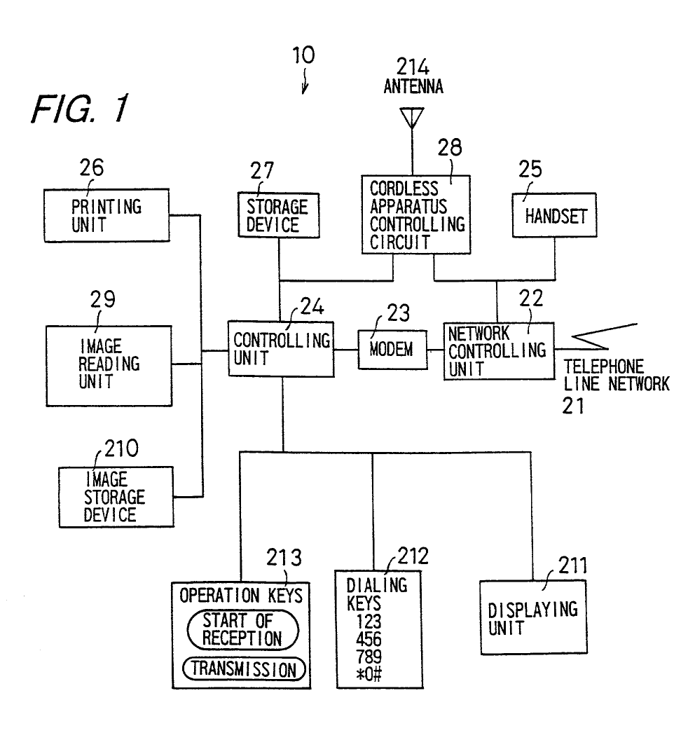

FIG. 1 is a block diagram showing a configuration of a facsimile apparatus 10 as an embodiment of the invention. The facsimile apparatus 10 is constituted by including a network controlling unit 22, a modem 23, a controlling unit 24, a handset 25, a printing unit 26, a storage device 27, a cordless apparatus controlling circuit 28, an image reading unit 29, an image storage unit 210, a displaying unit 211, dialing keys 212, operation keys 213, and an antenna 214.

The facsimile apparatus 10 is connected to an external telephone line network 21 with the network controlling unit 22. The network controlling unit 22 monitors conditions of the telephone line network 21 and carries out switching between a line to the modem 23 side, and a line to the hand set 25 side and the cordless apparatus controlling circuit 28 side. The modem 23 modulates a digital signal of an image to an analog signal suited for the telephone line network 21 and carries out demodulation of an analog signal in the telephone line network 21 to a digital signal for printing. The printing unit 26 is a unit for carrying out printing of a received image or an image read out by the image reading unit 29 and includes a thermal system, an electrophotographic system, and an ink jet system. The storage device 27 stores programs for operating the facsimile apparatus 10, a first table and a second table. The image reading unit 29 is a subject copy reading unit for facsimile transmission and copying and includes a reading system as a scale down reading system with a combination of a lens system and a CCD line sensor, or a contact image sensor system using a rod lens array. The image storage unit 210 is a unit for storing read images and received images. By providing this unit, there become feasible many complicated functions such as transfer or broadcast of received images, intercepting and memory transmission. Further, the image storage unit 210 is also used for storing images transmitted and received by the functions according to the invention. In a facsimile apparatus on a called side, each of later described image boxes is allotted to the image storage unit 210.

The controlling unit 24 is controlling means for controlling so that a call out is made by combining a facsimile number of a selected destination and the items of the additional information. The controlling unit 24, by using the program stored in the storage device 27, determines an operation of the whole apparatus, provides instructions for the whole apparatus, and furthermore, provides instructions for display of the displaying unit 211 on a basis of items of information inputted by the operation keys 213 and the dialing keys 212, items of information informing conditions of units in the apparatus, items of information of signals from the telephone line network 21. The controlling unit 24 further carries out compression of image data for shortening transmission time and expansion for converting the compressed image signals back to the original pixel array information. The operation keys 213 and the dialing keys 212 are selecting means for selecting a facsimile number of a destination and items of additional information from each of the tables with items of information and instructions inputted to the apparatus by a user. Hereafter, the operation keys 213 and the dialing keys 212 are collectively called “panel keys” in some cases. The displaying unit 211 is displaying means for displaying for the user an operation method and the contents in the first and second tables, and the like. By using the displaying unit 211, the operation keys 213 and the dialing keys 212, setting of various kinds of parameters in the facsimile apparatus becomes possible. Data in each of the tables according to the invention are also inputted interactively with the operation keys 213 and the dialing keys 212 used according to displayed contents of the displaying unit 211. Thus, the tables can be prepared by using publicly known technology. The handset 25 is provided with a receiver and a transmitter for telephone communication. The facsimile apparatus 10 can be connected to one or a plurality of cordless handsets. The cordless apparatus controlling circuit 28 is a device for controlling cordless handsets not shown and includes a tuner and associated devices for searching channels for connection to cordless handsets, establishing the connections, carrying out conversation, and transmitting and receiving radio waves. The antenna 214 is for carrying out radio wave transmission and reception for communications with the cordless handsets.

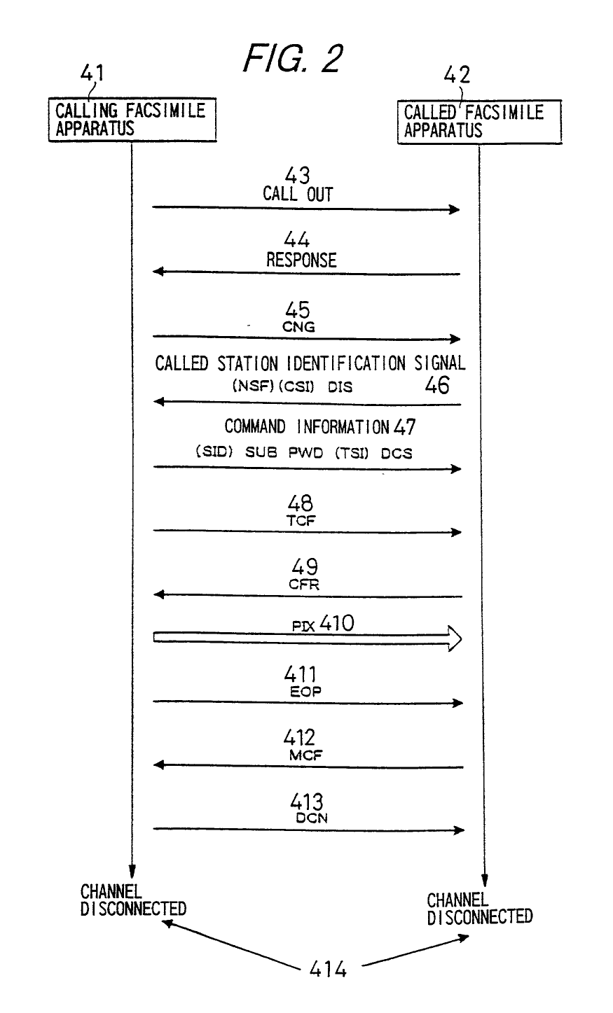

FIG. 2 is a diagram showing a transmission control procedure in the facsimile apparatus. The procedure shown in the figure is the most basic one for transmitting one page of images from a calling facsimile apparatus 41 to a called facsimile apparatus 42. First, when the calling facsimile apparatus 41 places a call out 43 with a dialed signal, the called facsimile apparatus 42 catches the channel to make a response 44. The calling facsimile apparatus 41 then transmits a CNG (calling tone) 45 to notify the called facsimile apparatus 42 that the communication is a facsimile communication. On receiving the CNG 45, the called facsimile apparatus 42 transmits a called station identification signal 46 to notify with a DIS (digital identification signal) in the called station identification signal 46 that the called facsimile apparatus 42 is capable of receiving a DIS (digital identification signal), a SUB (sub-address) signal and a PWD (password) signal. In the called station identification signal 46, an NSF (nonstandard function identification signal) and a CSI (called station identification signal) are option signals, about which explanations will be omitted here.

The calling facsimile apparatus 41, which made a decision that the called facsimile apparatus 42 is capable of receiving the SUB signal and the PWD signal by the DIS in the received called station identification signal 46, then transmits the SUB signal and, as necessary, the PWD signal simultaneous with a DCS (digital command signal) as next command information 47. Here, TSI (transmitting station identification signal) and SID are option signals, about which explanations will be omitted. Thereafter, in order to make characteristics of the modem match a condition of a channel for an image communication, the calling facsimile apparatus 41 transmits a TCF (training confirmation signal) 48. Immediately after the calling facsimile apparatus 41 receives a CFR (confirmation of reception signal) 49, which indicates that the training is successfully completed, transmitted from the called facsimile apparatus 42, the calling facsimile apparatus 41 transmits PIX (pixel data) 410 as image data to the called facsimile apparatus 42. On completion of the communication, the calling facsimile apparatus 41 transmits an EOP (end of procedure signal) 411 for cutting connection. The calling facsimile apparatus 41 receives an MCF (message confirmation signal) 412 from the called facsimile apparatus 42 and then feeds a DCN (disconnection command signal) 413 to disconnect the channel.

The SEP (selective polling) signal is used in selective polling in which a calling side requests a called side for transmitting an image. Thus, the procedure of the selective polling becomes a little different from the procedure shown in FIG. 2. Nevertheless, the request for transmitting the image is transmitted from the calling facsimile apparatus 41 to the called facsimile apparatus in a similar procedure.

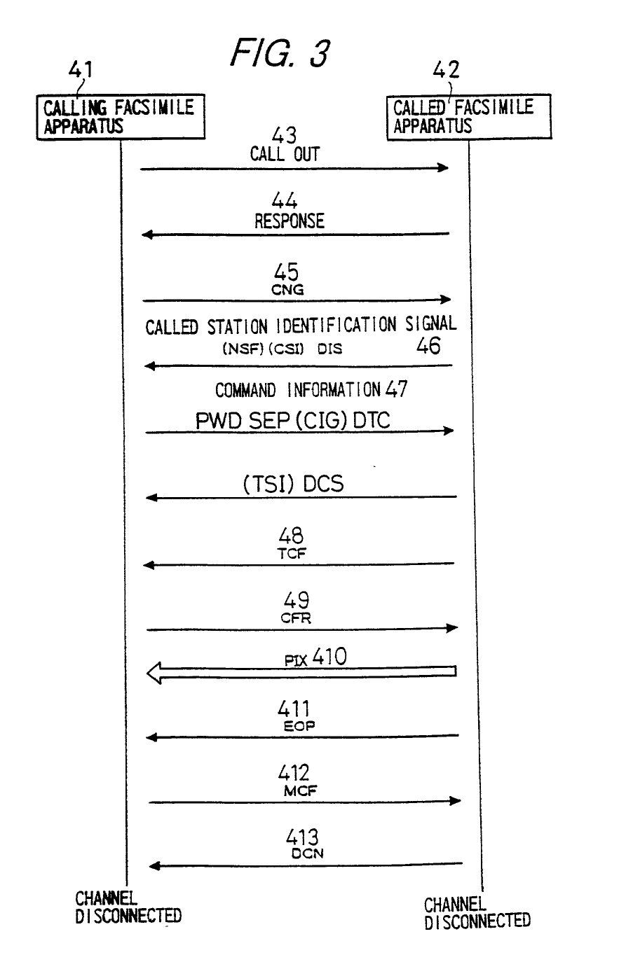

FIG. 3 is a diagram showing a transmission control procedure for selective polling in the facsimile apparatus. During selective polling, likewise to FIG. 2, a call out 43, a response 4, a CNG 45, and a called station identification signal 46 are transmitted between the calling facsimile apparatus 41 and the called facsimile apparatus 42. The called facsimile apparatus 42 notifies the calling facsimile apparatus 41, with a DIS in the called station identification signal 46, of its capability of receiving an SEP (selective-polling) signal and a PWD signal. In the called station identification signal 46, an NSF and a CSI are option signals, about which explanations will be omitted here. The calling facsimile apparatus 41, which made a decision that the called facsimile apparatus 42 is capable of receiving the SEP signal and the PWD signal by the DIS in the received called station identification signal 46, then transmits the SEP signal and, as necessary, the PWD signal simultaneous with a DTC (digital transmission command) as next command information 47 to the called facsimile apparatus 42. Here, a CID is an option signal, about which explanations will be omitted. Subsequently, the called facsimile apparatus 42 transmits a DCS to the calling facsimile apparatus 41. Here, a TSI is an option signal, about which explanations will be omitted. Thereafter, in order to make characteristics of the modem match a condition of a channel for an image communication, the called facsimile apparatus 42 feeds a TCF 48. Immediately after the called facsimile apparatus 42 receives a CFR 49, which indicates that the training is successfully completed, transmitted from the calling facsimile apparatus 41, the called facsimile apparatus 42 transmits PIX 410, as image data, to the calling facsimile apparatus 41. On completion of the communication, the called facsimile apparatus 42 feeds an EOP 411 for cutting connection. Then, the called facsimile apparatus 42 receives an MCF 412 from the calling facsimile apparatus 41 and then feeds a DCN 413 to disconnect the channel.

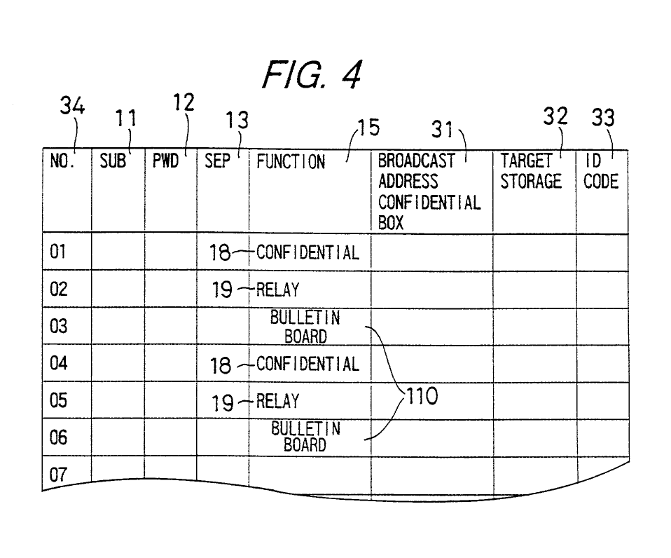

FIG. 4 is a view of a managing table stored in the called facsimile apparatus. In each cell, there is stored an item of information such as a facsimile number. However, for easiness in viewing the figure, stored items are made omitted.

A box number column 34 is provided for distinguishing boxes from one another which are for storing image data in the image storage unit 210 in the facsimile apparatus on the called side. The boxes are provided for respective four functions, confidential, relay, bulletin board, and circulation. The called facsimile apparatus selects a box in which a sub-address stored in a SUB column 11 is identical with contents of a SUB signal transmitted from a calling facsimile apparatus. When a password is further stored in a PWD column 12, the called facsimile apparatus ascertains whether or not the password in a PWD signal transmitted from the calling side is identical with a password stored in the PWD column 12 of the box. Only in the case the passwords are identical, the transmitted image data is stored in the box.

When a function column 15 of the selected box is specified as being confidential 18, the image data is transferred to a confidential box shown in a broadcast address/confidential box column 31. For confidential, an address of a confidential box is stored in the broadcast address/confidential box column 31. For broadcast, facsimile numbers of destinations for the broadcast are stored in the broadcast address/confidential box column 31. In a target storage column 32, there is stored an address of a reception box for storing the image data. In the case of confidential, an ID code is inputted at the called facsimile apparatus. Only when the inputted ID code is identical with a value in an ID code column 33, the image is printed out, so that the confidential function is performed to allow the image to be kept confidential.

When the designated box is a relay 19, received image data must be transmitted again to addresses stored in the broadcast address/confidential box column 31. In the broadcast address/confidential box column 31, there are stored facsimile numbers of the destinations as targets of the broadcast, to which the image data is automatically transmitted.

When the function column 15 of the designated box is specified as being bulletin board 110, image data having been already stored in a storage designated in the target storage column 32 is to be transmitted to the calling facsimile apparatus 41. In this case, however, only when contents of the SEP signal received from the calling facsimile apparatus 41 is identical with the value in the SEP column 13 in FIG. 3, the image data is transmitted from the called facsimile apparatus 42 to the calling facsimile apparatus 41. This provides a function of a bulletin board 110 for the facsimile apparatus.

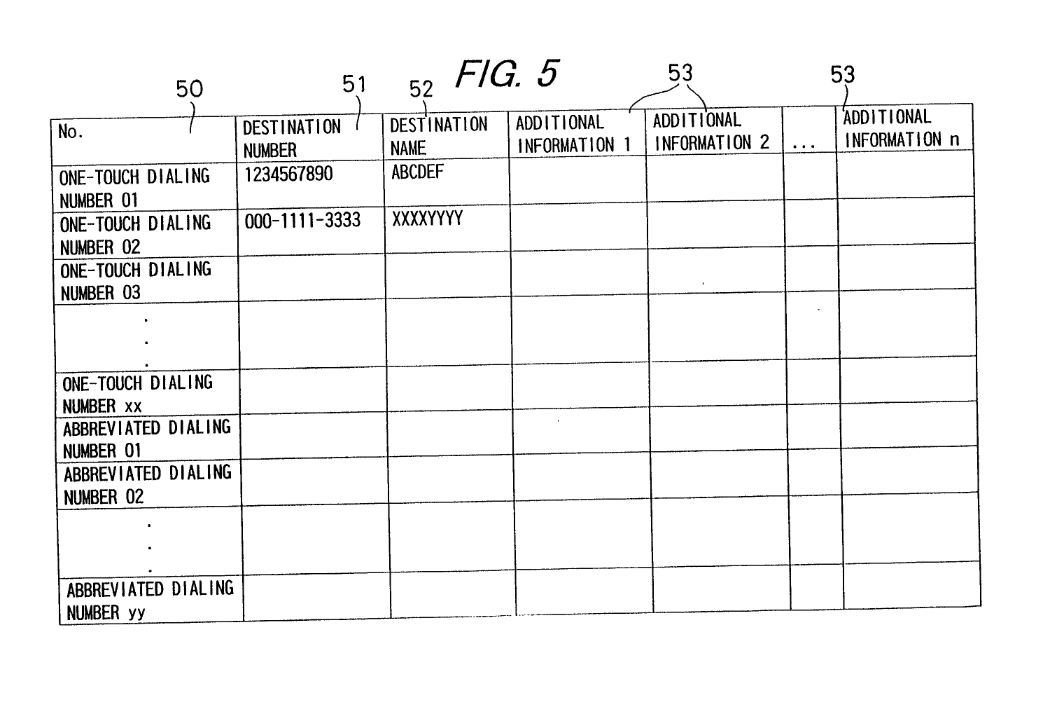

FIG. 5 is a diagram showing a first table according to the invention. The first table 1 includes a one-touch/abbreviated dialing column 50, a destination number column 51, and a destination name column 52. The one-touch/abbreviated dialing column 50 is assigned a predetermined number of one-touch dialing numbers 01 to xx and abbreviated dialing numbers 01 to yy. The destination number column 51 stores facsimile numbers of destinations corresponding to the one-touch dialing numbers 01 to xx and abbreviated dialing numbers 01 to yy. The destination name column 52 stores destination names corresponding to the facsimile numbers represented respectively by the one-touch dialing numbers 01 to xx and abbreviated dialing numbers 01 to yy. Moreover, the first table may include a column 53 for storing additional information on default for each of the one-touch dialing numbers 01 to xx and abbreviated dialing numbers 01 to yy.

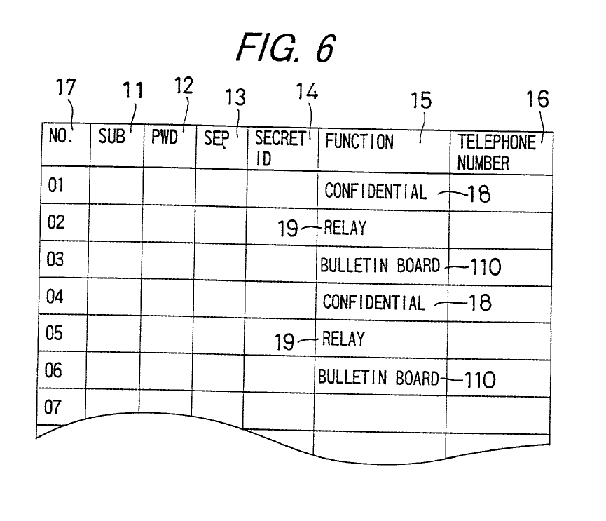

FIG. 6 is a view showing a second table according to the invention. The calling facsimile apparatus 41 must transmit procedure signals shown in FIG. 2 to the called facsimile apparatus 42 with the procedure signals made to include the SUB signal and the PWD signal, or the SEP signal. In this case, as shown in FIG. 5, a method of selecting a facsimile number of the destination has been already established by which a number already stored in the first table is selected by abbreviated dialing or one-touch dialing. In addition, a method of selecting the destination for placing a call is also established. In the method, there are displayed on the displaying unit 211 a plurality of facsimile numbers and names of destinations as contents of the first table, from which an intended destination is selected for placing the call. Thus, in the invention, in addition to the first table stored with the names and the facsimile numbers of destinations, there is displayed a second table as shown in FIG. 6. From the displayed items in the second table, a user selects necessary items of the additional information and transmits the items. This allows the user to easily select and transmit the items of the additional information. For example, facsimile numbers or names of destinations as contents of the first table are displayed on the displaying unit 211. Therefore, the user selects the destination, to which the user desires to transmit a facsimile, by using the dialing keys 212 and the operation keys 213. When the desired destination is selected, items of the additional information of contents in the second table are displayed on the displaying unit 211. When the user selects items of the additional information desired to be transmitted, the controlling unit 24 transmits the items of the additional information to the selected destination.

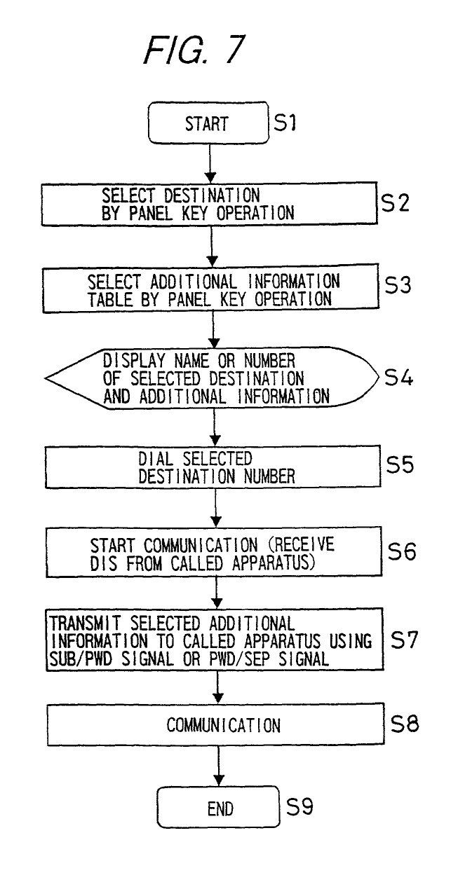

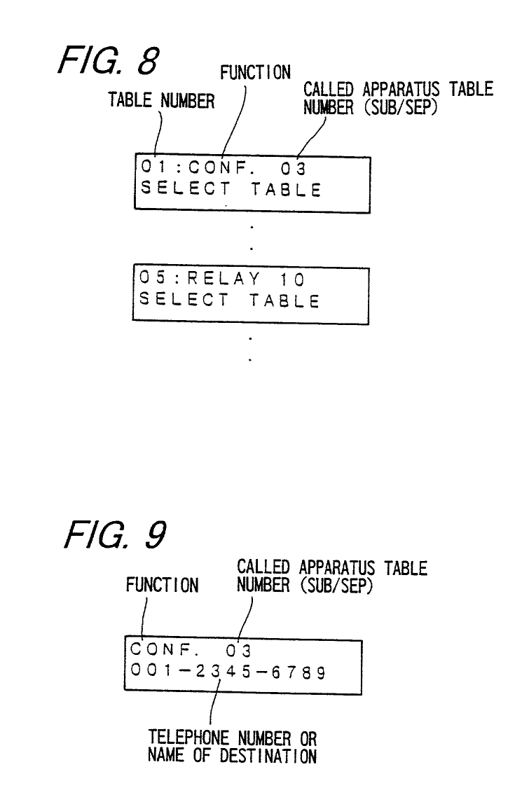

FIG. 7 is a flow chart showing an operation procedure of the controlling unit 24 of the facsimile apparatus embodying the invention. At step S1, the controlling unit 24 is activated. At step s2, the controlling unit 24 drives the displaying unit 211 to display the contents of the first table, i.e. facsimile numbers or names of destinations, so that the user selects destinations. After completion of destination selection made by the user, at step s3, as shown in FIG. 8, the controlling unit 24 drives the displaying unit 211 to display the contents of the second table, i.e. the additional information table, so that the user selects targeted additional information. FIG. 8 is a diagram showing contents displayed in the displaying unit 211 for selection of additional information. The displayed contents shown in FIG. 8 include: table numbers listed in the column 17 shown in FIG. 6; function names listed in the function column 15; box numbers 34 of the called-facsimile-apparatus-side managing table for specifying SUB or SEP signals shown in FIG. 4, i.e. table numbers; and a phrase allowing the user to make selection. Such displayed contents may be separately displayed according to table number, or may be listed with a plurality of table numbers. After the user selects additional information, predetermined operations are performed in accordance with the selected additional information. When a calling transmission function such as a confidential or relay function is selected, the controlling means 24 drives the image reading unit 29 to read an image of subject copy. Then, the procedure goes to step s4. When a calling reception function such as bulletin-board or selective-polling function is selected, the procedure goes to step s4. FIG. 9 is a diagram showing contents displayed in the displaying unit 211 after selection of destination and additional information. As shown in FIG. 9, at step s4, the controlling unit 24 drives the displaying unit 211 to display the selected destination name, or facsimile number as well as additional information. Subsequently, at steps s5 through s8, as shown in FIG. 2 or 3, the calling facsimile apparatus dials the selected destination number (step s5) to start communication (step s6), and transmits the selected additional information to the called facsimile apparatus with SUB or PWD signals in calling transmission, or with PWD or SEP signals in calling reception (step s7). In this way, the calling and called facsimile apparatuses are in communication with each other under the control of the controlling unit 24 (step s8). After completion of the communication, the procedure goes to step s9. Hereupon, the operation comes to an end. In the invention, although additional information is selected after selection of destination, it may be selected instead prior to selection of destination.

When contents stored in the second table are displayed, functions for the destination stored in the function column 15 as confidential, relay, and bulletin board are also displayed at the same time. In addition, for a plurality of the same functions, they can be stored and displayed as confidential 1 and confidential 2 so that they can be distinguished. This allows the user to select and transmit items of the additional information in accordance with a function the user desires to use.

When the calling facsimile apparatus 41 is used by a plurality of users, or when a user is absent who necessitates functions such as selection and transmission of items of additional information according to the invention, the apparatus must be set so that such functions are not used. In such a case, the functions according to the invention can be made canceled. For canceling and resetting the functions, an ID code and a password determined beforehand are inputted by using the dialing keys 212 and the operation keys 213. Furthermore, without canceling all of the functions according to the invention, all or only a part of contents of the second table can be made secret. For items of information desired to be made secret, an ID code is stored in a secret ID column 14. The box with the secret ID code stored in the secret ID column 14 is not displayed on the displaying unit 211 at selection of items of the additional information, thereby making the selection impossible. Thus, particularly highly confidential information of a destination can be protected. With the ID code stored in the secret ID column 14 inputted by a user who can use the secret information operating the dialing keys 212 and the operation keys 213, the items of the information can be disclosed to be selected and transmitted.

In the second table, a column 16 is provided for storing information specifying the destination such as a facsimile number or a name of the destination, in which column the facsimile number or the name of the destination or the like is stored. When a facsimile number or name of the destination stored in the column 16 of a box is identical with a facsimile number or name of a destination selected from the first table by a user, an item of information stored in the box is displayed with priority. For example, the item of the information is given with a different color or a typeface from others, an underline, or inverted characters. This can distinguish the item of the information from others to facilitate selection thereof.

Although the invention has been explained only about a facsimile apparatus as explained above, it is to be understood that the invention is not limited to the facsimile apparatus, but may be applied to communication apparatus and information processing apparatus each having a facsimile function.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A facsimile apparatus comprising:
a first table for storing a facsimile number of a destination of call;
a second table for storing items of additional information to be transmitted to the destination;
selecting means for separately selecting the destination and the items of the additional information from the first table and the second table; and
controlling means for controlling so that, when the destination and the items of the additional information are selected, a call out is made by combining the facsimile number of the selected destination and the items of the additional information.

2. The facsimile apparatus of claim 1, wherein the items of the additional information include at least one of a sub-address (SUB) signal, a password (PWD) signal, and a selective polling (SEP) signal.

3. The facsimile apparatus of claim 2, wherein the SUB signal, the PWD signal, and the SEP signal are corresponding to signals with functions of F-code specified by CIAJ (Communications Industry Association of Japan) or functions equivalent thereto.

4. The facsimile apparatus of claim 1, wherein facsimile numbers and names of destinations on the other end are stored in the first table, information items defining characteristics of the items of the additional information are stored in the second table and that displaying means for displaying the facsimile number or the name of the destination, and the information items defining the characteristics of the items of the additional information during the selection.

5. The facsimile apparatus of claim 1, wherein a function for making a call out by using contents of the first or second table can be canceled and reset.

6. The facsimile apparatus of claim 1, wherein all or a part of contents of the second table are made secret and, after a user is identified as being allowed to use the contents of the second table, the contents are disclosed.

7. The facsimile apparatus of claim 1, wherein items of information designating a destination are stored in the second table and, when displaying contents of the second table, items of additional information in the second table corresponding to a facsimile number or name of a destination selected from the first table are displayed with priority.
